(19) United States
(12) Patent Application Publication
(10) Pub. No.: US 2008/0225037 A1
(43) Pub. Date: Sep. 18, 2008

(54) APPARATUS AND METHOD FOR TRUNCATING POLYHEDRA

(76) Inventor: Basimah Khulusi, Kansas City, MO (US)

Correspondence Address: LATHROP & GAGE LC, 2345 GRAND AVENUE, SUITE 2800, KANSAS CITY, MO, 64108, US

(21) Appl. No.: 11/686,496

(22) Filed: Mar. 15, 2007

(51) Int. Cl. G06F 17/00

(52) U.S. Cl. 345/418

(57) ABSTRACT

An apparatus for creating truncated polyhedra without using complex formulas and without requiring advanced computer processors and computer memory according to one embodiment includes at least one processor, means for inputting vertex data to the processor, a display in data communication with the processor, and computer memory coupled to the processor. The computer memory has recorded within it machine readable instructions for storing vertex data previously input to the processor, truncating a polyhedron created using the vertex data, and actuating the display. The instructions for truncating a polyhedron utilize length data and angle data for triangles formed from the vertex data.

### BACKGROUND OF THE INVENTION

It has been theorized that a single simple rule generates all known complexity demonstrated by matter. Nevertheless, matter is currently described and depicted using many complex formulas. While drafting and geometrical computer programs have become commonplace, they rely on numerous complex formulas and require advanced computer processors and computer memory.

### SUMMARY OF THE INVENTION

One method disclosed herein for truncating polyhedra includes the steps:
Providing vertex data.
Establishing lines with known lengths between the vertices.
Establishing triangles with known angles from the established lines. Some triangles form triangular faces of vertices of a polyhedron, and other triangles are polyhedron virtual triangles with two of their sides forming two non-adjacent edges at the vertex of the polyhedron.
Forming polygons that define the faces of the polyhedron using the triangular faces that overlap.
Establishing a truncating base for each vertex.
Placing each vertex vertically, and forming a truncating base triangle that defines the truncating base using three adjacent horizontal vertices at the equator.
Establishing the truncating base at the horizontal vertex where the value of each corner angle of the two triangular faces is the most acute.
Forming two of the truncating base lines of the vertex to be truncated using two sides of the truncating base triangle.
Noting that each polyhedron virtual triangle that joins two non-adjacent edges of the vertex that needs to be truncated intersects at a determined intersecting angle with the established truncating base triangle.
Calculating the lengths of the rest of the truncating base lines that complete the truncating base for each vertex using the intersecting angles.
Forming a truncating virtual polygon with the truncating base lines as its sides from the truncating base.
Forming truncating virtual triangles that have sides with known lengths and angles from the truncating base lines.
Forming new base apical triangles from the truncating base lines of the truncating base. Those base apical triangles are the new triangular faces of the vertex with its truncating base delineated.
Forming new apical triangles from new truncating lines parallel to the truncating base lines; forming new truncating lines at an angle to the truncating base; or forming new apical triangles from lines parallel to the lines at an angle with the truncating base to truncate at an angle.
Establishing the dimensions of the new truncating triangles with known side lengths from the new truncating lines.
Forming a new truncating polygon from the new truncating triangles.
Plotting all measurements on the polyhedral net of the polyhedron.
Modifying one of the new apical triangles to become a new polygonal face formed of triangles of dimensions equal to the triangles of the new truncating polygon.
Forming one side of one triangle of the new polygonal face from the new truncating line of the new apical triangle.
Drawing the new polygonal face on the polyhedral net in such a way that when folded, its sides will coincide with the sides of the new truncating polygon.
Forming the new polygonal face of the new truncated polyhedron from this new modified apical triangle.
Optionally truncating the vertices of the polyhedron at their truncating bases, though when one vertex is truncated at its truncating base, its adjacent vertices that belong to the truncating base cannot be truncated. When one vertex is not truncated at its truncating base, the truncation of its adjacent vertices is limited by the amount of its truncation.

An apparatus for creating truncated polyhedra without using complex formulas and without requiring advanced computer processors and computer memory according to one embodiment includes at least one processor, means for inputting vertex data to the processor, a display in data communication with the processor, and computer memory coupled to the processor. The computer memory has recorded within it machine readable instructions for storing vertex data previously input to the processor, truncating a polyhedron created using the vertex data, and actuating the display. The instructions for truncating a polyhedron utilize length data and angle data for triangles formed from the vertex data.

An apparatus for creating truncated polyhedra according to another embodiment includes at least one processor, means for inputting vertex data to the processor, a display in data communication with the processor, and computer memory coupled to the processor. The computer memory has recorded within it machine readable instructions for storing vertex data previously input to the processor, truncating a polyhedron created using the vertex data and actuating the display. The instructions for truncating a polyhedron utilize length data and angle data for triangles formed from the vertex data and do not require advanced computer processors and advanced computer memory.

An apparatus for determining properties of polyhedra without using complex formulas and without requiring advanced computer processors and computer memory according to one embodiment includes at least one processor, means for inputting vertex data to the processor, a display in data communication with the processor, and computer memory coupled to the processor. The computer memory has recorded within it machine readable instructions for storing vertex data previously input to the processor, the vertex data being associated with a polyhedra, creating triangles using the vertex data, determining at least one property of the triangles, determining at least one property of the polyhedra using the at least one determined property of the triangles, and actuating the display.

### BRIEF DESCRIPTION OF THE DRAWINGS

FIG. 1 is a perspective view of a polyhedron according to an embodiment.

FIG. 2 is a polyhedral net of the polyhedron of FIG. 1.

FIG. 3 is the polyhedral net of FIG. 2 after being modified according to an embodiment.

FIG. 4 is the polyhedral net of FIG. 2 after being modified according to an embodiment.

FIG. 5 is the polyhedron of FIG. 1 after being modified according to an embodiment.

FIG. 6 is the polyhedron of FIG. 1 after being modified according to an embodiment.

FIG. 7 schematically shows elements of an apparatus for creating truncated polyhedra according to an embodiment.

### DESCRIPTION OF THE PREFERRED EMBODIMENT

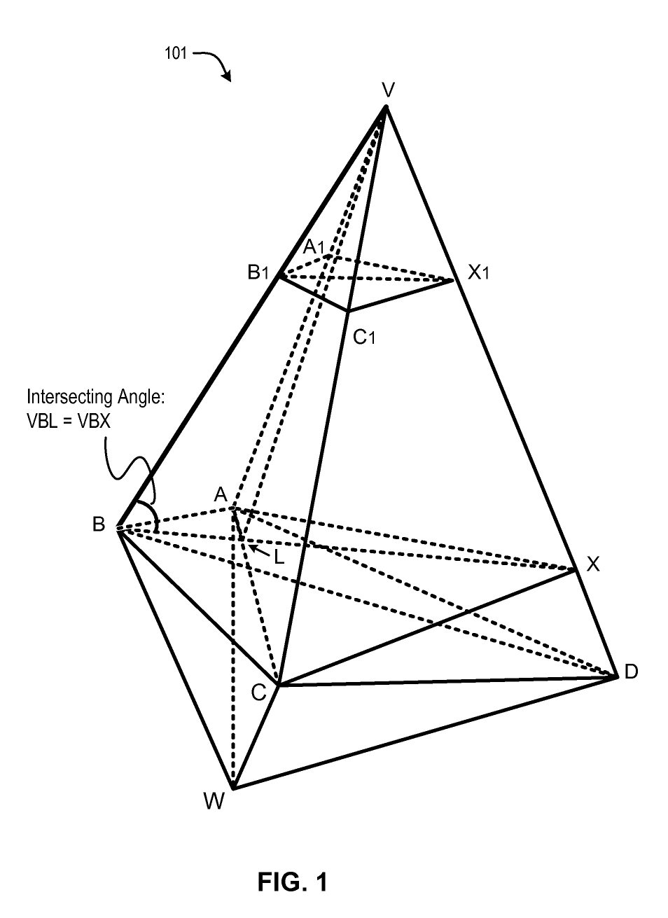

An apparatus and method according to the present invention will now be described in detail with reference to FIGS. 1 through 7 of the accompanying drawings.

According to one embodiment disclosed herein, all truncated polyhedra can be generated using the simple mathematics of calculating angles and side lengths of triangles. The infinite amount of truncated polyhedra thus generated may form an infinite amount of complex polyhedra, including all of the geometric complexity.

FIG. 1 shows a polyhedron 101 constructed using method disclosed herein. At a first step of the method, the three-dimensional coordinates of the vertices (A, B, C, D, V, W) are provided. The method then proceeds to a second step, where the length of every line segment connecting the vertices (A, B, C, D, V, W) is determined using simple algebra. Those line segments form triangles (ABC, ABD, ABV, ABW, ACD, ACV, ACW, ADV, ADW, AVW, BCD, BCW, . . . ). Some of these triangles form triangular faces of the vertices of the polyhedron 101 (ABV, ABW, AWD, BCW, BCV, CDV, CDW, ADV) while others of these triangles form polyhedron virtual triangles with two sides being non-adjacent edges of the vertex. Adjacent vertices may have overlapping triangles, and the rest of the triangles may intersect. Putting all of the triangular faces together provides all the faces of the polyhedron 101 and all of its vertices. The method then proceeds to a third step, where all of the angles of all of the triangles are calculated. The method then proceeds to a fourth step, where a vertex of the polyhedron 101 may be truncated. Notably, by determining the properties (e.g., dimensions, etc.) of the triangles that form the faces of the polyhedron, the dimensions of the faces of the polyhedron may be easily determined.

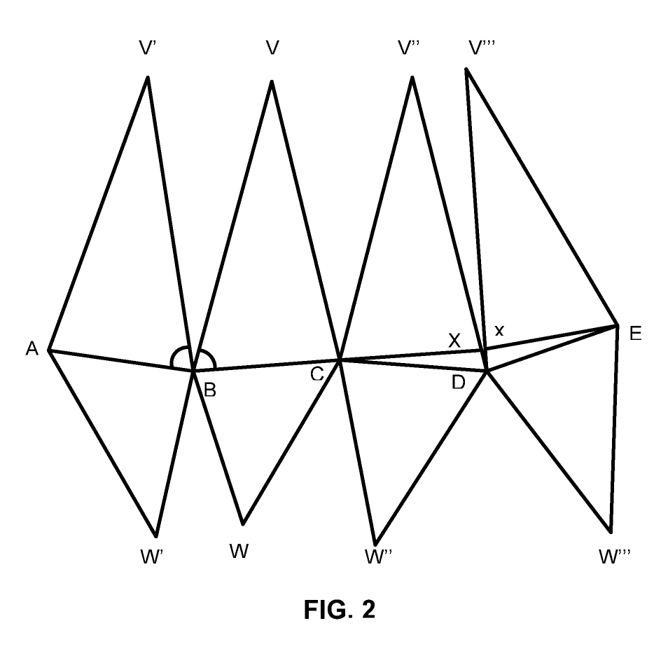

At the fourth step of the method, at least one of the vertices is truncated (e.g., V). While the truncation of vertex V is described in great detail, it should be appreciated that a different or additional vertex may be truncated following the steps set forth herein. To truncate the vertex, a planar truncating base is established. Viewing the polyhedral net 102 (FIG. 2) of the polyhedron 101, the truncating base is established at the most acute angles at the central vertices (A, B, C, D, E). Suppose we use the 3 adjacent Vertices A, B, C at the equator to form the truncating base triangle ABC which will determine the truncating base and two truncating base lines AB and BC. That truncating base intersects edge VD at point X. To establish point X, we calculate the intersecting angle between edge VB and line BL, which is formed where polyhedron virtual triangles VBD and ABC intersect. This is angle VBX.

Point L is located where BX intersects AB, and angle VBX is equal to angle VBL. The intersecting angle is then determined using the known angles ABC, ABD, and DBC in polyhedron virtual triangles ABC, ABD and DBC. The ratio of angle ABD to angle DBC is equal to the ratio of angle ABL to angle LBC. Angle LBC is equal to angle ABC minus angle ABL. Therefore, ABD/DBC is equal to ABL/(ABC-ABL), and angle ABL is calculated. Knowing angles ABL and BAC and length AB in virtual triangle ABL, simple algebra and/or trigonometry is used to calculate the lengths of BL and AL. Because the lengths of AL and AV are known and angle VAL is equal to angle VAC in virtual triangle VAL, simple algebra and/or trigonometry is used to calculate angles ALV and AVL and length VL. Knowing lengths VL and VB and BL in virtual triangle VBL, we calculate angle BLV and the intersecting angle VBL which is equal to VBX. Because angle VBL is equal to angle VBX, angle BVX is equal to angle BVD, and length BV in virtual triangle VBX is known, we calculate length BX and length VX and thus establish X.

Because lengths VX and VC are known and angle CVX is equal to angle CVD in triangle CVX, we calculate the length of truncating base line CX. Because lengths VX and VA are known and angle AVX is equal to angle AVD in triangle AVX, we calculate the length of truncating base line XA. Thus, together with truncating base lines AB and BC, we establish the truncating base ABCX. If length VX is greater than length VD, the real truncating base A′B′C′D that is at a plane parallel to ABCX must be established. Truncation would then be parallel or at an angle to A′B′C′D.

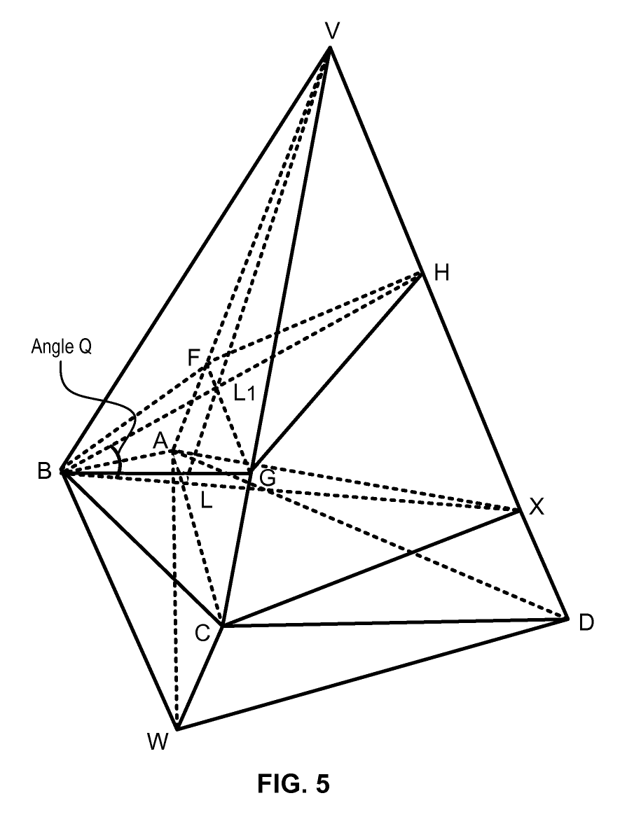

Vertex V is then truncated in one of the following ways. It can be truncated at its truncating base by determining the length of BX, which is the third edge of the virtual triangle BVX and also the third edge of the virtual triangles BCX and BAX. Or, it can be truncated at a plane parallel to its truncating base by determining new truncating lines (A1)(B1), (B1)(C1), (C1)(X1), and (X1)(A1) with lengths that may be calculated as explained below. This provides new truncating polygon (A1)(B1)(C1)(X1). Each two of these new truncating lines (A1)(B1), (B1)(C1), (C1)(X1), and (X1)(A1), form a new truncating virtual triangle. New truncating virtual triangles (A1)(B1)(X1), and (B1)(X1)(C1) have a 3rd side (B1)(X1) that is also the 3rd side of another virtual triangle (B1)V(X1) formed by two non-adjacent edges of the vertex to be truncated. From the above, length (B1)(X1) is determined. Or, it can be truncated at an angle to its truncating base (FIG. 5), or at a plane parallel to a truncating plane that is at an angle with the truncating base. When the Vertex V is truncated at its truncating base, the adjacent vertices A, B and C that form the truncating base triangle cannot be truncated. When the Vertex V is not truncated at its truncating base, however, the adjacent vertices can be truncated by an amount limited by the truncation of vertex V.

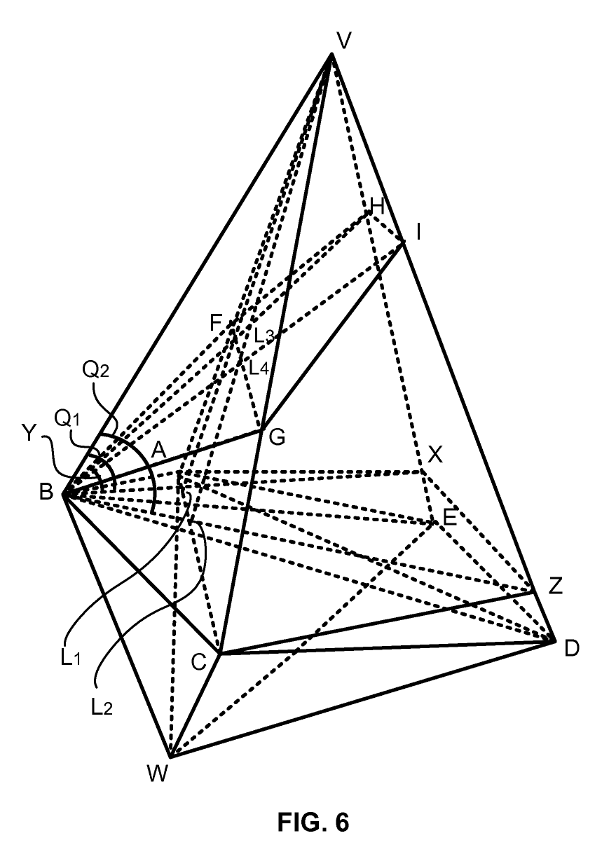

The same method described above may be used to establish the value for all the intersecting angles needed to establish the truncating base when the Vertex to be truncated has more than four faces, like for example in a Decahedron (FIG. 6). In FIG. 6, Vertex V has five faces, so we need to establish the values of two intersecting angles (Q1) and (Q2). (Q1) is established since the ratio of angles ABE/EBC is equal to the ratio of angles AB(L1)/(L1)BC. Angle (L1)BC is equal to angle ABC minus angle AB(L1). Therefore, ABE/EBC is equal to AB(L1)/[ABC−AB(L1)], and angle AB(L1) may be calculated. (Q2) is established since the ratios of angles ABD/DBC is equal to the ratio of angles AB(L2)/(L2)BC. Angle (L2)BC is equal to angle ABC minus angle AB(L2). Therefore, ABD/DBC is equal to AB(L2)/[ABC−AB(L2)], and angle AB(L2) may be calculated. Then we continue the steps as described above in relation to FIGS. 1 and 2 to calculate angles (Q1) and (Q2).

### EXAMPLE

### Truncating the Octahedron Ad Infinitum (FIGS. 2, 3, 4)

Polyhedral nets are drawn using information gathered as set forth above. First, we draw the polyhedral net 102 with its truncating base delineated (FIG. 2). We can draw the triangular faces of the vertex V by drawing four triangles A(V′)B, B(V) C, C(V″)D, and D(V′″)E. When the polyhedral net 102 is cut and taped together, apices (V′)(V)(V″)(V′″) will meet to form vertex V of the polyhedron. Points B, C, D represent vertices B, C, D of the polyhedron. Point E will meet at point A to form vertex A of the polyhedron. We modify the polyhedral net to establish a truncating base for vertex V. We define the truncating base ABCX by drawing truncating base lines CX and xE on faces C(V″)D and D(V′″)E respectively. Together with truncating base lines AB and BC, they form base apical triangles A(V′)B, B(V)C, C(V″)X, and x(V′″)E. X and x of the polyhedral net meet at point X of the polyhedron.

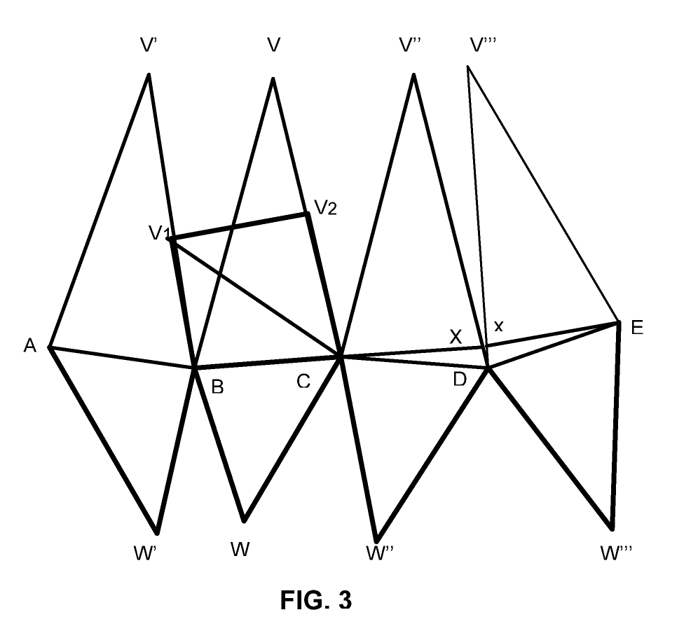

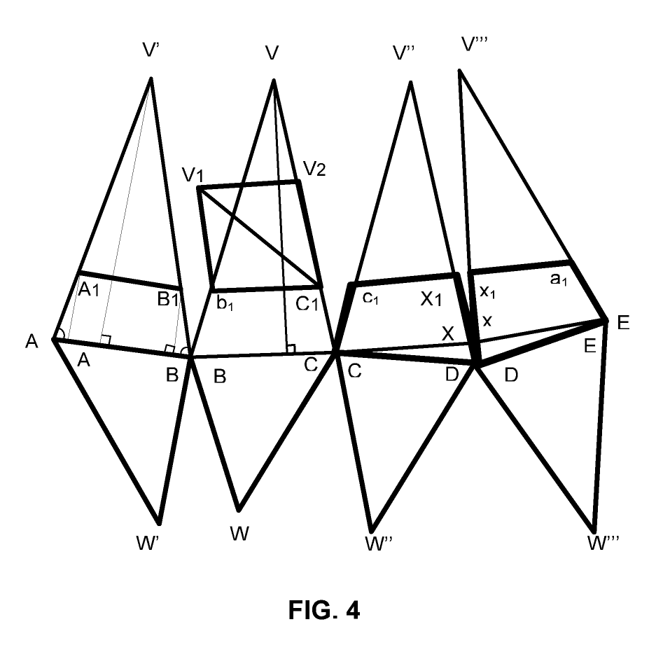

We can truncate at the truncating base (FIG. 3), or if not, we may continue to modify the Polyhedral Net. FIG. 4 shows truncation at a plane parallel to the truncating base. On each base apical triangle of the Vertex V, we either draw lines that are parallel to the truncating base lines, or we draw lines at an angle to the truncating base, or we draw lines parallel to the lines that are at an angle to the truncating base. These new truncating lines are drawn at distances and angles that we chose from a limited range as explained below. Knowing distances and angles allows us to calculate the lengths of these new truncating lines. These new truncating lines will form the new edges of the truncated polyhedron. These new truncating lines will form new truncating virtual triangles that will form a new truncating polygon. That new truncating polygon is the vertex figure. It will determine the new polygonal face of the new truncated polyhedron.

As shown in FIGS. 1 and 4, truncating at a new truncating plane (A1)(B1)(C1)(X1) that is parallel to truncating base ABCX gives us new truncating lines (A1)(B1), (b1)(C1), (c1)(X1), and (x1)(a1) on the polyhedral net. Points (B1) and (b1), (C1) and (c1), (X1) and (x1), (a1) and (A1) of the polyhedral net, meet to form points (B1), (C1), (X1), and (A1) of the polyhedron respectively. On the polyhedron net, when truncating at planes parallel to the truncating base, the distance between the truncating base and the parallel planes should be less than the length of the smallest of the latitudes of triangles VBC and VAB (i.e. the perpendicular from V to BC, and the perpendicular from V to BA respectively).

We draw each new truncating line (A1)(B1), (b1)(C1), (c1)(X1), and (x1)(a1) on its respective base apical triangle. These new lines form new apical triangles (A1)(V′)(B1), (b1)(V)(C1), ((c1)(V″)(X1) and (x1)(V′″)(a1). We chose the length of the transversal line between the two parallel lines. That transversal line forms one side of each one of the two corner apical triangles of each base apical triangle. Knowing the length of that transverse line and two angles of each corner apical triangle (one corner angle and one ninety-degrees angle), we calculate the lengths of the other two sides of each one of the two corner apical triangles. That gives us the lengths of two sides of the new apical triangles. Knowing the lengths of two sides of the new apical triangles together with the known apical angle at the apex, we can calculate the lengths of the new truncating lines (A1)(B1), (b1)(C1), (c1)(X1), and (x1)(a1). We know the angle between two non-adjacent edges of the polyhedron VB and VD from FIG. 1, and the lengths of the two non-adjacent sides of the new apical triangles calculated above (b1)(V) and (X1)(V″). Knowing one angle and the lengths of two sides gives us the length of the third side (B1)(X1). That gives us the length of the third side (B1)(X1) of the new truncating virtual triangles (B1)(C1)(X1) and (B1)(A1)(X1). Thus, in an octahedron, the new truncating lines form two new truncating virtual triangles that meet to form a new truncating polygon, in this instance a new truncating quadrilateral.

On the net in FIG. 4, we modify any one of the new apical triangles. Assuming we modify triangle (b1)(V) (C1), this triangle will become a new quadrilateral face formed of two triangles with dimensions equal to those of the new truncating quadrilateral. The new truncating line of that new apical triangle forms one side of one of the two triangles of the new quadrilateral face. The new quadrilateral face is oriented on the net in a way that the common side of its two triangles has a common point with the common side (B1)(X1) of the two triangles that form the new truncating quadrilateral.

As an example in FIG. 4, we can modify new apical triangle (b1)V(C1) to get new quadrilateral face (b1)(V1)(V2)(C1) formed of two triangles (b1)(V2)(C1) and (b1)(V1)(V2). We draw triangle (b1)(V2)(C1) with sides (b1)(C1), and (b1)(V2) equal to (B1)(X1), and (C1)(V2) equal to (c1)(X1) and we draw triangle (b1)(V1)(V2) with sides (b1)(V1) equal to (B1)(A1) and (V1)(V2) equal to (a1)(x1) and side (b1)(V2). We then separate the new polyhedral net around the perimeter. We separate along (A)-(A1), (A1)-(B1), (B1)-(B), (B)-(b1), (b1)-(V1), (V1)-(V2), (V2)-(C1), (C1)-(C), (C)-(c1), (c1)-(X1), (X1)-(D), (D)-(x1),(x1)-(a1) and (a1)-(E). We separate around the rest of the perimeter of the polyhedral net of the octahedron, fold the folding lines, and tape the adjacent edges together.

### EXAMPLE

### Truncating at an Angle (Q) to the Truncating Base

The following example truncates at an angle (Q) to the truncating base starting at point B. To start truncating at point A or C or X, the same steps described below could be followed as well. The angle values we can truncate at should be less than the value of angle VBX. On the polyhedron, we draw Line BH at an angle (Q) with line BX, where (Q) is less than angle VBX and where H is a point on VX. Knowing angles (Q) and BXV, and length of BX in triangle BXH, we calculate lengths of HX and HB, and determine point H. BH intersects VL at point (L1). We need to draw a line FG which passes through (L1), with F being a point on AV, and G being a point on CV. We need to determine points F and G.

Suppose we need to draw line FG at parallel to AC. Knowing angle (L1)BL is equal to (Q) and angle BLV, and length of BL, we calculate length of (L1)L in triangle (L1)BL. Knowing that angle V(L1)G is equal to VLC (which is equal to 180−VLA) that angle (L1)GV is equal to ACV, and that length V(L1) is equal to VL−(L1)L, in triangle V(L1)G we calculate length of (L1)G and length of VG and establish G. Knowing angle V(L1)F is equal to VLA, and angle (L1)FV is equal to CAV, and length V(L1) in triangle V(L1)F, we calculate length of (L1)F and length of VF and establish F. Knowing VF and VG and angle FVG in triangle FVG, we calculate length of FG. We connect points B, F, H, G, and B to get new truncating lines BF, FH, HG and GB. Knowing angle BVA and lengths of BV and FV in triangle BVF, we calculate length of FB. Knowing angle XVA and lengths of FV and VH in triangle FVH, we calculate length of FH. Knowing angle XVC and lengths of HV and VG in triangle HVG, we calculate length of HG. Knowing angle CVB and lengths of GV and BV in triangle GVB, we calculate length of GB. New truncating lines BG and GH with BH form one new truncating triangle BGH. New truncating lines BF and FH with BH form another new truncating triangle BFH. Those two new truncating triangles form the new truncating polygon BGHF which determines the new polyhedron face which is the Vertex figure of Vertex V.

We can chose to have (F1)(G1) be at an angle (Y) to AC and FG. (F1)(G1) also passes through (L1). When A(F1) is less than AF, we do the following calculations. In virtual triangle F(L1)(F1), we know angle (F1)(L1)F is equal to (Y), angle (L1)F(F1) is equal to 180−VAC, and length F(L1), we calculate length of F(F1), and establish (F1). In virtual triangle G(L1)(G1), we know angle (G1)(L1)G is equal to (Y), and angle (L1)G(G1) is equal to ACV; and length G(L1) is also known. We calculate length of G(G1), and establish (G1). When C(G1) is less than CG, we do the following calculations. In virtual triangle G(L1)(G1), we know angle (G1)(L1)G is equal to (Y), and angle (L1)G(G1) is equal to 180−ACV; and length G(L1) is also known. We calculate length of G(G1), and establish (G1). In virtual triangle F(L1)(F1), we know angle (F1)(L1)F is equal to (Y), and angle (L1)F(F1) is equal to VAC; and length F(L1) is also known. We calculate length of F(F1), and establish (F1). Then we transfer all the above information to a polyhedral net, and we continue the same steps described above to modify the polyhedral net to end up with the new polygonal face of the new polyhedron. We can also truncate at lines parallel to the above described new truncating lines that are at an angle.

### EXAMPLE

### Truncating a Decahedron (FIG. 6)

The same method used for truncating above can be used to truncate any vertex of any polyhedron with n edges. For example, to truncate a vertex with five faces, we do all the calculations including the two intersecting angles (Q1) and (Q2) with the truncating base triangle ABC. We calculate lengths of A(L1), (L1)(L2), and (L2)C. We have two truncating base lines AB and BC. We calculate the lengths of the other three other truncating base lines CZ, ZX, and XA. We truncate at base or parallel to base or at an angle to the base etc. If we are truncating at an angle (Y) to base, we draw BH at an angle (Y) to BX. It intersects V(L1) at point (L3). The following takes FG parallel to AC, with F being a point on AV, and G on CV. FG passes through point L3. We establish points F and G following the same exact steps as for the octahedron above. We determine length of FG. We determine point (L4) where V(L2) intersects FG using (L3)(L4)/FG is equal to (L1)(L2)/AC. We establish the fifth vertex I of the new truncating pentagon where B(L4) intersects VZ. We create a new truncating pentagon BGIHF formed of three new truncating virtual triangles BGI, IBH, and HBF, whose sides we can calculate. We modify one of the new apical triangles to get a new pentagon face formed of three triangles with dimensions equal to the dimensions of the triangles of the new truncating pentagon. We can chose to have (F1)(G1) be at an angle (Y1) to AC and FG. (F1)(G1) also passes through (L3). We do all calculations as for the octahedron above.

For a vertex with six faces, we get a new hexagon face formed of four triangles. For the vertex with seven faces, we get a new heptagon face formed of five triangles. For the vertex with eight faces, we get a new octagon face formed of six triangles. For the vertex with 9 faces, we get a new nonagon face formed of seven faces. For the vertex with ten faces, we get a new decagon face formed of eight triangles etc. We use the method described previously to calculate the lengths of all the sides of all the new truncating virtual triangles that form the new truncating polygons that define the new polygonal faces.

### Implementation of and Apparatus for Practicing the Disclosed Method

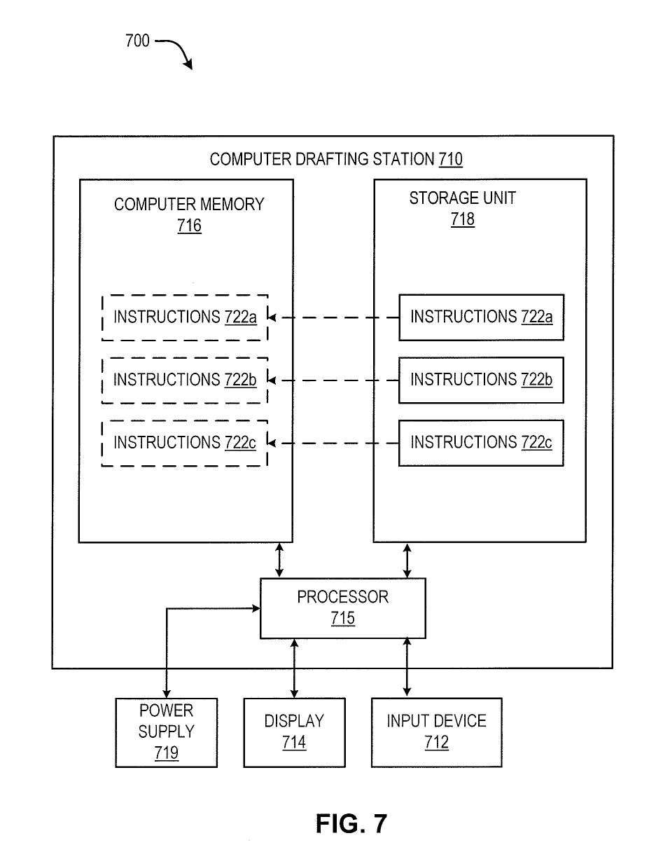

FIG. 7 shows an apparatus 700 for creating truncated polyhedra without using complex formulas and without requiring advanced computer processors and computer memory. Apparatus 700 includes a computer drafting station 710. Computer drafting station 710 includes an input device 712 (e.g., a keyboard, mouse, trackball, joystick, or any other device that may be used to input electronic data) and a display 714 (e.g., a computer display, a projection device, a LCD display, a cathode ray tube display, a plasma display, a LED display, or any other appropriate display). Drafting station 710 may further include at least one processor 715, computer memory 716, and a storage unit 718. The storage unit 718 may be, for example, a disk drive that stores programs and data of the computer drafting station 710. It should be appreciated that the computer drafting station 710 may be constructed without the storage unit 718, though the storage unit 718 may provide additional programming flexibility. The processor 715 is in data communication with the input device 712, the display 714, and the computer memory 716. A power supply 719 (i.e., AC power or DC power, including a battery or a solar cell, for example) is electrically coupled to the processor 715 to power the processor 715.

The storage unit 718 is illustratively shown storing (and providing to computer memory 716) machine readable instructions 722a for storing vertex data input to the processor 715 via the input device 712, machine readable instructions 722b for implementing the method set forth above to truncate a polyhedron created using the vertex data, and machine readable instructions 722c for actuating the display 714 to present data. As noted above, the instructions may be contained in the computer memory 716 without use of the storage unit 718.

It is understood that while certain forms of this invention have been illustrated and described, it is not limited thereto except insofar as such limitations are included in the following claims and allowable functional equivalents thereof.

What is claimed:

1. An apparatus for creating truncated polyhedra without using complex formulas and without requiring advanced computer processors and computer memory, the apparatus comprising:
at least one processor;
means for inputting vertex data to the processor;
a display in data communication with the processor; and
computer memory coupled to the processor and having recorded within it machine readable instructions for:
storing vertex data previously input to the processor;
truncating a polyhedron created using the vertex data; and
actuating the display;
wherein the instructions for truncating a polyhedron utilize length data and angle data for triangles formed from the vertex data.

2. The apparatus of claim 1, wherein the means for inputting vertex data includes a keyboard.

3. The apparatus of claim 1, wherein the display is a computer display.

4. The apparatus of claim 1, further comprising means for powering the processor.

5. The apparatus of claim 1, wherein the instructions for truncating a polyhedron include instructions for:
providing vertex data;
establishing lines with known lengths between the vertices;
establishing triangles with known angles from the established lines to form triangular faces of vertices of a polyhedron with some of the triangles and to form polyhedron virtual triangles with others of the triangles;
forming polygons that define the faces of the polyhedron using overlapping triangular faces;
establishing a truncating base for each vertex; and
forming a truncating base triangle that defines a truncating base using three adjacent horizontal vertices at an equator.

6. The apparatus of claim 5, wherein the instructions for truncating a polyhedron include instructions for:
forming two truncating base lines at the vertex to be truncated using two sides of the truncating base triangle;
calculating the lengths of additional truncating base lines that complete the truncating base for each vertex;
forming a truncating virtual polygon with the truncating base lines from the truncating base as its sides;
forming truncating virtual triangles that have sides with known lengths and angles from the truncating base lines; and
forming new base apical triangles from the truncating base lines of the truncating base, the new base apical triangles being new triangular faces of the vertex with its truncating base delineated.

7. The apparatus of claim 6, wherein the instructions for truncating a polyhedron include instructions for forming new apical triangles from new truncating lines parallel to the truncating base lines.

8. The apparatus of claim 6, wherein the instructions for truncating a polyhedron include instructions for forming new truncating lines at an angle to the truncating base.

9. The apparatus of claim 6, wherein the instructions for truncating a polyhedron include instructions for forming new apical triangles from lines parallel to the lines at an angle with the truncating base to truncate at an angle.

10. The apparatus of claim 6, wherein the instructions for truncating a polyhedron include instructions for:
forming new truncating lines;
establishing the dimensions of new truncating triangles with known side lengths from the new truncating lines; and
forming a new truncating polygon from the new truncating triangles.

11. The apparatus of claim 10, wherein the instructions for truncating a polyhedron include instructions for:
plotting all measurements on a polyhedral net;
modifying a respective new apical triangles to create a new polygonal face formed of triangles of dimensions equal to the triangles of the new truncating polygon; and
forming one side of one triangle of the new polygonal face from the new truncating line of the new apical triangle.

12. The apparatus of claim 11, wherein the instructions for truncating a polyhedron include instructions for:
drawing the new polygonal face on the polyhedral net in such a way that when folded, its sides will coincide with the sides of the new truncating polygon; and
forming the new polygonal face of the new truncated polyhedron from the new modified triangle.

13. The apparatus of claim 12, wherein the instructions for truncating a polyhedron include instructions for truncating the vertices of the polyhedron at their truncating bases.

14. An apparatus for creating truncated polyhedra, the apparatus comprising:
at least one processor;
means for inputting vertex data to the processor;
a display in data communication with the processor; and
computer memory coupled to the processor and having recorded within it machine readable instructions for:
storing vertex data previously input to the processor;
truncating a polyhedron created using the vertex data; and
actuating the display;
wherein the instructions for truncating a polyhedron utilize length data and angle data for triangles formed from the vertex data; and
wherein the instructions for truncating a polyhedron do not require advanced computer processors and advanced computer memory.

15. The apparatus of claim 14, wherein the means for inputting vertex data includes a keyboard.

16. The apparatus of claim 14, wherein the display is a computer display.

17. The apparatus of claim 14, further comprising means for powering the processor.

18. An apparatus for determining properties of polyhedra without using complex formulas and without requiring advanced computer processors and computer memory, the apparatus comprising:
at least one processor;
means for inputting vertex data to the processor;
a display in data communication with the processor; and
computer memory coupled to the processor and having recorded within it machine readable instructions for:
storing vertex data previously input to the processor, the vertex data being associated with a polyhedra;
creating triangles using the vertex data;
determining at least one property of the triangles;
determining at least one property of the polyhedra using the at least one determined property of the triangles; and
actuating the display.

19. The apparatus of claim 18, wherein the at least one property of the triangles includes surface area.

20. The apparatus of claim 19, wherein the at least one property of the polyhedra includes surface area.
